(19) United States
(12) Patent Application Publication
(10) Pub. No.: US 2015/0088662 A1
(43) Pub. Date: Mar. 26, 2015

(54) Predictive Behavioural Targeting

(71) Applicants: Stephan Noller, Koln (DE); Richard Hutton, Berlin (DE)

(72) Inventors: Stephan Noller, Koln (DE); Richard Hutton, Berlin (DE)

(73) Assignee: nugg.ad AG, Berlin (DE)

(21) Appl. No.: 14/562,227

(22) Filed: Dec. 5, 2014

Related U.S. Application Data
(63) Continuation of application No. PCT/EP2012/069984, filed on Oct. 10, 2012.

(51) Int. Cl. G06Q 30/02; G06N 5/04; G06N 99/00

(52) U.S. Cl. CPC G06Q 30/0269; G06N 99/005; G06N 5/04
USPC 705/14.66

(57) ABSTRACT

It is inter alia disclosed a method, a computer program, an apparatus and a system for predictive behavioural targeting. Information on an access behaviour of a current user accessing content is obtained. At least one characteristic of the current user is predicted by a prediction module of the apparatus in response to the obtaining of the information on the access behaviour of the current user, the prediction at least being based on a model for the characteristic and on the obtained information on the access behaviour of the current user. The model is at least based on a set of parameters determined by a training module at least based on information from a plurality of training sets and provided to the prediction module from time to time for updating purposes.

### CROSS-REFERENCE TO RELATED PATENT APPLICATIONS

This patent application is a continuation of PCT/EP2012/069984, filed Oct. 10, 2012, the entire teachings and disclosure of which are incorporated herein by reference thereto.

### FIELD OF THE INVENTION

Embodiments of this invention relate to the field of predictive behavioural targeting.

### BACKGROUND OF THE INVENTION

Many owners or publishers of web pages wish to present information or advertisements to users that visit the web page, whereby said information is supposed to match with the user's characteristics in order to increase the value of the advertisement. This process is generally known as “targeting” of users. For this purpose, the web page and/or special service providers try to gain as much personal information about users as possible, whereby this information can be collected in different ways. For instance, in case of “behavioural targeting”, inter alia information on the browsing or “click” behaviour of users is analyzed. If such kind of information is merged with demographic data and/or data obtained from inquiries and surveys and if information about users is combined with information about other users with similar characteristics, for instance by collaborative filtering, it becomes possible to predict characteristics of users based on their browsing behaviour. This process is known as “predictive behavioural targeting”.

German Patent Specification DE 10 2004 047 815 B4 describes a method for generating and routing advertisements, whereby the browsing behaviour of a user is combined with data about the user's interests and personal information about the user. Control data for selecting advertisements based on this information is stored in user profiles for each user, and these user profiles are compared and completeness and similarities are analyzed.

It is vital for predictive behavioural targeting that characteristics of a user that is to be targeted are predicted as quick as possible, since, based on the predicted characteristics, usually an ad server has to make a further selection of information to be targeted to the user, thus incurring a further delay. Thus for instance, characteristics should be predictable in the order of some seconds or even some milliseconds.

One particularly straightforward approach to predict characteristics of a current user is to compare its browsing behaviour against a database that stores the browsing behaviour and associated characteristics of a plurality of users by identifying the user with the best-matching browsing behaviour and to use its associated characteristics as a prediction. Such an approach is generally known as a k-nearest-neighbour approach. Since the entire database has to be searched for each prediction, the prediction time is quite large. Furthermore, the entire database has to be accessible when a prediction shall be made.

Furthermore, it is generally desirable to be able to provide a quick prediction already when there is only few information on the browsing behaviour of a current user, for instance in case of a first-time user for which it is only known that he accessed the current web page. In the profile-based system described in DE 10 2004 047 815 B4, a profile would first have to be set up and enriched by profile information from profiles of other users considered to be similar to the current user, which may take a considerable amount of time.

### SUMMARY OF THE INVENTION

It is thus, inter alia, an object of the invention to provide an improved solution for predictive behavioural targeting.

According to a first aspect of the invention, a method performed by at least one apparatus is disclosed, the method comprising:
obtaining information on a access behaviour of a current user accessing content;
predicting, by a prediction module of the apparatus and in response to the obtaining of the information on the access behaviour of the current user, at least one characteristic of the current user at least based on a model for the characteristic and on the obtained information on the access behaviour of the current user, wherein the model is at least based on a set of parameters determined by a training module at least based on information from a plurality of training sets and provided to the prediction module from time to time for updating purposes, wherein each training set of the training sets comprises, for a respective training user of a plurality of training users, information on an access behaviour of this respective training user and information on the characteristic of this respective training user, and
providing information on the predicted characteristic of the current user to allow targeting of information to the current user at least based on the information on the predicted characteristic.

According to a second aspect of the invention, a computer program is disclosed, comprising program code for performing the method according to the first aspect of the invention or any of its below-described embodiments, when the computer program is executed on a processor. The computer program may for instance be distributable via a network, such as for instance the Internet. The computer program may for instance at least partially represent software and/or firmware of a processor. The computer program may for instance be storable and/or encodable in a computer-readable medium. The computer-readable medium may for instance be embodied as an electric, magnetic, electro-magnetic, optic or other storage medium, and may either be a removable medium or a medium that is fixedly installed in an apparatus or terminal. Non-limiting examples of such a computer-readable medium are a Random-Access Memory (RAM) or a Read-Only Memory (ROM). The computer-readable medium may for instance be a tangible medium, for instance a tangible storage medium. A computer-readable medium is understood to be readable by a computer, such as for instance a processor.

According to a third aspect of the invention, an apparatus is disclosed, configured to perform the method according to the first aspect of the invention or any of its below-described embodiments or comprising respective means for performing the method steps of the method according to the first aspect of the invention or any of its below-described embodiments.

According to a fourth aspect of the invention, an apparatus is disclosed, comprising at least one processor and at least one memory including computer program code, the at least one memory and the computer program code configured to, with the at least one processor, cause the apparatus at least to perform the method according to the first aspect of the invention or any of its below-described embodiments.

The apparatus according to the third and fourth aspect of the invention may in particular be the apparatus that performs the method according to the first aspect of the invention and comprises the prediction module.

According to a fifth aspect of the invention, a system is disclosed, comprising an apparatus according to the third or fourth aspect of the invention, and the training module.

In the following, exemplary features and exemplary embodiments that equally apply to the first, second, third, fourth and fifth aspect of the invention will be described. All exemplary features and exemplary embodiments shall be understood to be disclosed also in all possible combinations with each other.

Information on an access behaviour of a current user accessing content is obtained. The content may for instance be any type of content that can be accessed by a user, in particular a human user, for instance content of the Internet or of any other network such as for instance a social network. The content may for instance be electronic content, for instance content that can be viewed or listened to. In particular, a web page of the Internet shall be understood as an example of content that can be accessed by a user, for instance via a web browser such as for instance the Internet Explorer, Mozilla Firefox or Apple's Safari browser. A web page may for instance be part of a set of one or more related web pages forming a web site. The term “current user” is used in this specification to denote a user that is accessing content and shall be targeted, for instance during and/or after accessing of the content. Beyond this, the term “current” is not to be construed to be of limiting nature. The access behaviour of the current user may for instance pertain to the accessing of content by the current user. For instance, if the content comprises one or more web pages, the access behaviour may for instance pertain to the accessing of the web pages by the current user and may then for instance be understood as the click behaviour of the current user. The information on the access behaviour may then for instance comprise information on the types (e.g. in terms of content categories) and/or frequencies of web pages accessed by the current user. Information on the access behaviour of the current user may for instance be gathered by means of a cookie, in particular a third-party cookie. The information on the access behaviour of the current user may already consider the content currently accessed by the current user, or may not yet consider it. The information on the access behaviour of the current user may for instance be obtained from a cookie processing unit, which may form part of the apparatus or may be a separate unit with respect to the apparatus.

In response to the obtaining of the information on the access behaviour of the current user, at least one characteristic of the current user is predicted by a prediction module of the apparatus, at least (or only) based on a model for the characteristic and on the obtained information on the access behaviour of the current user. The characteristic may for instance be a demographic characteristic of the user, like the gender, an age, an age range, an income or an income rage, to name but a few non-limiting examples. Equally well, the characteristic may pertain to an interest of the user, such as for instance an interest in a specific topic or product.

The model is at least based on a set of parameters determined by a training module and provided to the prediction module from time to time for updating purposes. Therein, the training module may form part of the apparatus or may form part of a unit that is separate from the apparatus. The prediction module and the training module may be understood to be functionally separated and/or decoupled. The prediction module applies the model to the obtained information on the access behaviour of the current user to predict a characteristic of the current user. The training module provides—from time to time (e.g. in regular or irregular time intervals)—the set of parameters on which the model applied by the prediction module is based. The prediction module is thus free to operate independently with respect to the training module, based on the set of parameters it presently has. If there is an update for this set of parameters, this update is provided by the training module to the prediction module. However, the determining of the set of parameters by the training module and/or the provision of the update of the set of parameters to the prediction module may in particular not be performed in response to the obtaining of the access behaviour of the current user. In contrast, determining and/or provision of an update for the set of parameters may for instance be triggered by other events, as will be discussed below. The prediction of the characteristic of the current user on the one hand and the determining and/or provision of updates for the set of parameters on the other hand may thus be considered to be asynchronous with respect to each other. The link between both processes may then be considered to be constituted by the updates provided from the training module to the prediction module. The functional separation of prediction and training allows vastly speeding up the prediction time (i.e. the time required to predict a characteristic of the current user based on the obtained information on his/her access behaviour). Prediction is thus no longer slowed down by training (as it would be the case in lazy learning). Furthermore, the use of a parameter-based model for the prediction (rather than a huge database of respective profiles and/or respective sets of access behaviour and associated characteristics of users, which may contain information for millions of users) also allows quickly predicting characteristics of a current user even if there is only few information on the access behaviour of the current user (e.g. only information on the content currently accessed by the current user). The functional separation of prediction and training also allows operating the prediction module as an online module (e.g. as part of a web server), that handles in-coming requests for prediction of the characteristics of the current user based on the information on the access behaviour of the current user obtained (e.g. together) with the request and immediately (e.g. with a delay of milliseconds only, e.g. with an average delay of less that 10, 20, 50, 100 or 500 milliseconds) provides the predicted characteristic. The online module may thus operate in real-time. In contrast, the training module may be operated as an offline module, which may for instance not serve requests in real-time. A new set of parameters may for instance be determined and/or provided to the prediction module by the training module if a sufficient number of new and/or updated training sets based on which the set of parameters is determined has been obtained. Alternatively, or additionally the training module may perform the determining and/or providing of the set of parameters on a regular schedule. In any case, a frequency of predicting the characteristic of a current user (as performed by the prediction module) may be larger than a frequency of determining and/or providing the set of parameters (as performed by the training module).

The training module determines the set of parameters at least based on information from a plurality of training sets, wherein each training set of the training sets comprises, for a respective training user of a plurality of training users, information on an access behaviour of this respective training user and information on the characteristic (and possibly also of further characteristics) of this respective training user. Therein, the term “training user” defines a user for which both information on his/her access behaviour and information on the characteristic is available (and constitutes a training set) and is used by the training module to determine an update for the set of parameters (or the initial version thereof). This term shall not be construed to be further limiting in any sense. A training user may for instance differ from a regular or normal user in that he/she provided information on the characteristic voluntarily (e.g. by participating in a survey) or in that information on the characteristic is otherwise available for this user (e.g. from a database, e.g. a Nielsen database). It should be noted that the current user may also be a training user, for instance if the current user provides information on the characteristic. Since the training sets comprise information on both the access behaviour and the characteristic for a plurality of training users, the training module can derive the set of parameters there from that allows to predict, based on information on the access behaviour of the current user and the model that is based on this set of parameters, also the characteristic of the current user. Therein, the set of parameters may not comprise any training sets. It rather may be understood as a (mathematical) generalization of the information of some or all training sets. In particular, at least one parameter of the set of parameters (or even some or all parameters of the set of parameters) depends on information from a plurality of training sets (or even all training sets) of the training sets. Thus even when the prediction module and the training module would both operate in response to the obtaining of information on the access behaviour of a current user (i.e. would not operate asynchronously), the overall system would still completely differ from a lazy learning system, in that there is always an intermediate step of determining a set of parameters based on the training sets, which set of parameters is then applied via the model to the information on the access behaviour of the current user in a further step.

The predicted characteristic of the current user is then provided, for instance to an ad server (either directly or indirectly) or to another entity, to allow targeting of information to the current user at least based on the information on the predicted characteristic. For instance, if the characteristic is an age or gender or interest of the current user, this information may be valuable for an appropriate selection of information (such as for instance advertisements or recommendations) that is to be provided to the current user. This targeting may for instance take place while the current user accesses the content, or thereafter.

According to an embodiment of all aspects of the invention, the characteristic of the current user is predictable by a classification of a vector representing the information on the access behaviour of the current user into one of at least two classes, and the model is based on a support vector machine that allows the classification. A support vector machine is a concept in statistics and computer science for determining a hyperplane or a set of hyperplanes in a multi-dimensional space to separate vectors contained in the multi-dimensional space and being associated with two or more classes. A good separation is for instance achieved if the hyperplane has the largest possible distance to the nearest vector of any class. An example of a representation of the information on the access behaviour of the current user as a vector is for instance the five-dimensional vector with components (0, 2, 3, 0, 6), which indicate that the current user has visited, in the available observation period, 0 web pages related to sports topics, 2 web pages related to business topics, 3 web pages related to arts topics, 0 web pages related to vehicle topics and 6 web pages related to fashion topics. Furthermore, if the characteristic of the current user is the gender of the current user, which is associated with the class “male” or “female”, such a vector may for instance be classified as “female”. The characteristic may of course alternatively be predictable by a classification of a vector into more than two classes. For instance, if the characteristic is an age range of the current user, this may be associated with a classification in the following age classes: 0-10, 11-20, 21-30, 31-45, 46-60, and 61-90 years of age.

In this embodiment, the set of parameters may for instance define a decision function of the support vector machine that is applicable to the vector representing the information on the access behaviour of the current user to perform the classification. The decision function may for instance be related to the one or more hyperplanes determined by the support vector machine. For instance, in case that the characteristic of the current user is predictable by a classification of a vector representing the information on the access behaviour of the current user into one of two classes, the set of parameters may for instance comprise components of a normal vector and a bias defining a hyperplane of the support vector machine. Prediction of the characteristic of the current user based on a decision function of a support vector machine may be considerably computationally inexpensive. It may for instance be sufficient to multiply each component (or only each non-zero component) of the vector with an associated parameter from the set of parameters, to sum up the result, to add one of the parameters from the set of parameters and to determine the sign of the overall result. This low complexity of the application of the decision function is particularly advantageous since it has to be applied in the prediction module, where real-time operation with smallest possible delays is desired.

In this embodiment, for each training set of the training sets, the information on the access behaviour of the respective training user comprised in the training set may represent a training vector that is associated with a class derivable from the information on the characteristic of the respective training user comprised in the training set, and the set of parameters may be determined by the training module to reflect a separation of training vectors of different classes according to a pre-defined optimization criterion. For instance, if the characteristic is a gender, each training set may for instance comprise the training vector (representing the information on the access behaviour of the training user) and information on the gender of the training user. The set of parameters is then determined to achieve a separation of the training vectors of male training users and the training vectors of female training users according to the pre-defined optimization criterion. The pre-defined optimization criterion may for instance be a maximization of the respective distance of the training vector that is closest to the hyperplane in both the male and female class of training vectors (co-called optimal hyperplane). Equally well, other optimization criteria may be applied. For instance, an optimization criterion leading to a soft margin hyperplane may be applied.

According to an embodiment of all aspects of the invention, the information on the access behaviour of the current user comprises, for each content category of a set of one or more content categories, information on how often accessing of content pertaining to the content category by the current user has been observed in a time period, and the information on the access behaviour of a respective training user comprised in the training sets respectively comprises, for each content category of a set of one or more content categories, information on how often accessing of content pertaining to the content category by the training user has been observed in a time period. The information on the access behaviour may then for instance take the shape of a content category histogram for a user. Non-limiting examples of content categories are sports, business, economy, art, fashion, cars, etc. The time period may for instance be a limited or unlimited time period, for instance the time period since the observation was started. The set of one or more content categories used for the current user and the set of one or more content categories used for the training users may for instance be the same, but may equally well at least partially be different. The information on how often accessing of content pertaining to the content category has been observed may pertain to a limited number of content sources only. For instance, if accessing content takes the form of visiting a web page, and if the web page visit is observed based on a third-party cookie, then only visits of web pages to which the third-party cookie pertains (for instance because the web page contains a request for information (e.g. a web bug) from the third-party web page that set the third-party cookie) are observed.

In this embodiment, a decision whether content pertains to one of the content categories is made by a decision unit based on a received content classifier and/or based on an analysis of at least a part of the content. The decision unit may for instance be part of the apparatus, or may be part of another apparatus that is separate from the apparatus. The decision unit may for instance be part of a cookie processing unit, which may in turn be part of the apparatus or may be separate there from. The information on the access behaviour of the current user may for instance be obtained by the apparatus or the prediction unit from the decision unit or the cookie processing unit. For instance, if a current user/training user (this notation is used to refer to either the current user or the training user in the following) accesses a web page (as an example of content) that has a request for data (e.g. a web bug or tracking pixel or script) from a third-party web page included therein (or associated therewith, for instance in the form of a script of tracking pixel that is associated with some or all web pages of a web site), the web server of the third-party web page (denoted as third-party web server) may require—upon the first communication with the web browser of the current/training user—the web browser of the current/training user to set a cookie (e.g. a small text file) and to provide the contents of the cookie each time when requesting content from the third-party web page. The request for data (e.g. the web bug) from the third-party web page may be furnished with a content classifier or with an identifier (e.g. the Uniform Resource Locator (URL)) of the web page into which the request for data is included or with which the request for data is associated. Thus when the request for data from the third-party web server is launched by the web browser of a current/training user, the third-party web server is informed on the content of the web page into which the request for data has been included (or with which the request for data is associated) via the content classifier or can gain such information from an analysis of the (e.g. retrieved) contents of this web page based on the identifier (if no dedicated identifier is included in the request for data, also the HTML referer contained in the request towards the third-party web server may be used instead). Based on the knowledge of the content of the web page accessed by the current/training user, a content category histogram thus can be started or updated and written back into the cookie of the web browser of the current/training user. This content category histogram is then, together with the content classifier or an identifier of the web page, provided to the third-party web browser each time a web page including (or associated with) a request for data from the third-party web page is accessed by the current/training user.

In this embodiment, the predicting of the characteristic of the current user may be based on a representation of the information on the access behaviour of the current user in which the information on how often the current user has accessed content pertaining to content categories of the set of one or more content categories has been normalized, and wherein the set of parameters may be determined based on training sets in which the respective information on how often the respective training user has accessed content pertaining to content categories of the set of one or more content categories has been normalized. Normalizing the information on how often the current/training user has accessed content pertaining to content categories of the set of one or more content categories may for instance take into account that accesses to generally highly frequented contents have a smaller relevancy than accesses to generally lowly frequented contents. Normalizing of the information on how often the current user has accessed content pertaining to content categories of the set of one or more content categories may for instance be part of the predicting. For instance, the information on how often the current user has accessed content pertaining to content categories of the set of one or more content categories may be stored (e.g. in a cookie as described below) in non-normalized form and may only be normalized for the purpose of predicting the characteristics of the current user. Normalizing may for instance take into account the number of clicks of a current/training user per content category (e.g. in a period of time), an overall probability that a content category is clicked, and a total number of clicks of a current/training user (e.g. in the period of time).

According to an embodiment of all aspects of the invention, at least a part of the information on the access behaviour of the current user is stored in a cookie on a web browser of the current user and is provided by the web browser, for instance to a cookie processing system that forms part of the apparatus or is separate therefore. The part of the information on the access behaviour of the current user may for instance pertain to content accessed by the current user before the accessing of content (i.e. the current content). This part of the information on the access behaviour of the current user may then for instance be enriched by information on the current content (e.g. by a cookie processing unit or a decision unit, which may for instance form part of the cookie processing unit). This enriched information may then for instance be stored back in the cookie on the web browser. The part of the information on the access behaviour of the current user stored in the cookie may for instance be provided (e.g. in a HTTP GET request) because the cookie is associated with a domain/path-combination (a combination that specifies a domain and a path, wherein the path may equally well be a “/” only) that matches a domain/path-combination of a request for data (e.g. an image tag such as an HTTP IMG or a script) included in or associated with the content currently accessed by the current user. The cookie may for instance be a third-party cookie. The domain/path-combination may for instance specify a web page (or an entire web site comprising a plurality of web pages) that is associated with the apparatus, for instance since the apparatus is a web server (or a part thereof) for this web page (or web site). The initial setting of the cookie (and the subsequent updating of the cookie) may for instance have been triggered by the apparatus (for instance by a cookie processing unit thereof). The contents of the cookie may for instance be encrypted and/or compressed.

In this embodiment, at least a part of the information on the access behaviour of a training user of the training users may be stored in a cookie on a web browser of the training user, wherein at least a domain (or a domain/path-combination) for which the cookie has been set matches a domain (or a domain/path-combination) for which the cookie stored on the web browser of the current user has been set. The cookie set on the web browser of the current user and the cookie set on the web browser of the training user may thus for instance both be cookies set by the same entity, for instance a web server associated with the domain (or the domain/path-combination). The cookie may for instance be a third-party cookie. The apparatus may for instance be the web server or a part thereof. The apparatus may then for instance forward the information on the access behaviour of the training user stored in the cookie on the web browser of the training user to a database (which may form part of the apparatus or may be separate there from), wherein the training module has access to the database. When the cookies set on the web browser of the current user and of the training user are set by the same entity, this entity can control collection of information on the access behaviour of both the current user and the training user, both of which are required for predicting the characteristic of the current user.

According to an embodiment of all aspects of the invention, the information on the characteristic of a training user comprised in a training set of the training sets is obtained from a survey conducted with the training user and is associated with the information on the access behaviour of the training user to obtain the training set. The survey may for instance be an online survey. The survey may for instance be based on a set of questions to be answered by the training user. The characteristic may for instance be obtained as an answer to one question of the survey, or may be derivable from an analysis of respective answers to one or more questions of the survey. Participation in the survey may for instance be offered to a training user when a training user accesses content, for instance by an ad server. The survey may for instance be treated by the ad server like other advertisements managed by the ad server. Presentation of the survey may for instance be controlled by the ad server in a way that a minimum number of presentations of the survey per day are ensured. Optionally, presentation of the survey may be bound to a frequency cap to avoid that the survey is presented to often to the same user. A representation of answers given by the training user in response to the survey may for instance be provided (e.g. via a HTTP request) to the apparatus (or another entity that is separate from the apparatus), which combines this representation with information on the access behaviour of the training user. This combination may for instance be based on an identifier (for instance an anonymous or anonymized identifier) of the training user and/or of the web browser and/or the electronic device on which the web browser of the training user is running. As an example, a training user may be identified by an identifier (e.g. a so-called Unique User Identifier, UUID), that is stored in a cookie of the training user, and which is read out both when the training user participates in the survey and when information on the access behaviour of the training user is gathered. This can be accomplished by associating both the survey and web pages accessed by the training user with a web bug or script for tracking the training user, wherein the web bug or script for instance causes the same web server to be informed on participation of the training user in the survey and access of the training user to the web page. Alternatively, an electronic fingerprint of the device user by the training user for accessing web pages may for instance be used as identifier. The identifier may for instance be associated with the representation of answers of the survey given by the training user and with the information on the access behaviour of the training user. Additionally or alternatively, the information on the characteristic of a training user comprised in a training set of the training sets may be obtained from a data source, such as for instance a Nielsen database, or a database that stores (e.g. demographic) information about training users provided by the training users, for instance when registering for a service or when concluding a contract.

According to an embodiment of all aspects of the invention an actual address of the current user is anonymized by an anonymizer unit, and the information on the access behaviour of the current user is obtained with the anonymized address and not the actual address. The address may for instance be an Internet Protocol (IP) address of the user. The anonymizer unit may for instance be interposed between a web browser of the current user and the apparatus (which may for instance be a web browser or a part thereof). In this way, the actual address of the current user is unknown to the apparatus, so that privacy of the current user is protected. Similarly, also the actual address of the training users may be anonymized by the anonymizer unit, for instance when the information on the access behaviour and/or the information on the characteristic of the training user is provided. The anonymizer unit may for instance be a proxy server, for instance a reverse proxy server.

In this embodiment, the information on the predicted characteristic of the current user may for instance be provided with the anonymized address and not the actual address.

According to an embodiment of all aspects of the invention, the information on the predicted characteristic of the current user is formatted to match a format required by an ad server that performs the targeting of the information to the current user at least based on the information on the predicted characteristic. Different ad servers may for instance require different formats for the predicted characteristic. An example of a format is a key-value pair (like gender—male or age—20). Different ad servers may for instance use different key-value pairs, so that an according formatting may be inevitable. The formatting may for instance be performed by a formatting unit, which may form part of the apparatus or of another unit that is separate from the apparatus.

According to an embodiment of all aspects of the invention, the information on the predicted characteristic of the current user is provided to an ad server that performs the targeting of the information to the current user at least based on the information on the predicted characteristic. The information on the predicted characteristic may for instance be provided to the ad server directly or indirectly. For instance, the information on the predicted characteristic may be provided to a web browser of the current user and may then be provided by the web browser to the ad server, for instance by means of a location redirect that is enriched with information on the predicted characteristic. For instance, information on the access behaviour of the current user may first be provided to the apparatus (e.g. a web server) that predicts the characteristics of the current user in response to the obtained information on the access behaviour of the current user. The information on the access behaviour of the current user may for instance at least partially be stored in a cookie on the web browser of the current user (a further part of this information may for instance be a content classifier provided together with the contents of the cookie as explained above) and is provided (e.g. via HTTP GET) when the current user accesses content that is associated with the cookie (i.e. is provided at a domain/path-combination associated with the cookie). The response (e.g. via a HTTP response) to the web browser of the current user may then for instance contain an instruction to store updated information on the access behaviour of the current into the cookie on the web browser, and a location redirect request (e.g. via HTTP LOCATION) that specifies the address of the ad server and furthermore contains information on the predicted characteristic. In this way, thus information on the access behaviour of the current user can be gathered and information on the predicted characteristic can be provided to the ad server, with the only interference or change with content (e.g. a publisher's web page) to be accessed by the current user being adding a request for data (from a domain associated with the apparatus) into the content.

In this embodiment, the ad server may trigger storage of the information on the predicted characteristic in a cookie on a web browser of the current user. The information on the predicted profile is then available to the ad server at every web page that causes the web browser of the current user to provide the contents of the ad server's cookie to the ad server, for instance because a request for data (e.g. a web bug) associated with the ad server or a script for communication with the ad server is included in or associated with the web page. The ad server may thus perform predicted behavioural targeting (based on a past prediction of the characteristic of the current user provided by the apparatus) even when a web page accessed by the current user does not contain a request for data associated with the apparatus (that would trigger a new prediction), but does only comprise a request for data associated with the ad server (wherein the predicted characteristic stored in the ad server's cookie may of course become outdated after some time if it is not refreshed by the apparatus).

According to an embodiment of all aspects of the invention, an updated version of the set of parameters is determined by the training module and provided to the prediction module each time when a number of new and/or at least partially updated training sets have reached a pre-defined value. The training sets may for instance be stored in one or more databases. Therein, for instance the respective information on the access behaviour of the training users may be stored in a first part of the database (or a first database), and the respective information on the characteristic of the training users may be stored in a second part of the database (or a second database), wherein information pertaining to the same training user may for instance be linked via an identifier (e.g. an anonymous or anonymized identifier) of the training user. Alternatively, the training sets may be stored jointly in the same database, for instance after the information on the access behaviour of a training user and the information on the characteristic of the training user have been associated with each other. The information on the access behaviour of a training user comprised in a training set may for instance be updated each time when new information on the access behaviour of the training user becomes available (for instance when contents of a cookie set on a web browser of the training user and associated with an entity (e.g. the apparatus) that forwards this information to the database are provided). Similarly, the information on the characteristic of a training user may be updated when new related information becomes available, wherein this new information may for instance be obtained from an online survey and/or from other data sources. A training set may for instance be considered to be new if at least one of the information on the access behaviour of the training user and the information on the characteristic of the training user was not available before. A training set may for instance be considered to be at least partially updated if at least one of the information on the access behaviour of the training user and the information on the characteristic of the training has been updated. For instance, a single counter may be used to count both new incoming training sets and updated training sets. If the counter exceeds the pre-defined value, the training module may be triggered to determine an updated version of the set of parameters (for instance based on the new and the updated training sets only, or based on the new and the updated training sets as well as at least some training sets that are neither new nor updated (for instance all available training sets)) and to provide it to the prediction module. The pre-defined value may for instance have a first value in a start-up phase, and may have a second value in a phase following the start-up phase. For instance, the first value may be smaller than the second value, so that the set of parameters for the model becomes quickly available for prediction. An improved quality of the set of parameters then is obtained in the phase following the start-up phase.

According to an embodiment of all aspects of the invention, the apparatus is a web server or a part thereof. The web server may for instance be associated with a domain for which third-party cookies have been set in web browsers of the current user and the training users.

According to an embodiment of all aspects of the invention, the apparatus further comprises the training module. A processor of the apparatus then may for instance jointly implement the functionality of the prediction module and the functionality of the training module. These functionalities may however be handled by different threads of the processor. Alternatively, the apparatus may comprise separate processors for respectively performing the functionality of the prediction module and the functionality of the training module. Further alternatively, the training module may not be comprised in the apparatus, but may be comprised in an entity that is different from the apparatus (for instance in a server (e.g. a back-end server) that communicates with the apparatus).

According to an embodiment of all aspects of the invention, two or more characteristics of the current user are predicted, and each of the characteristics is predicted by a respective model. Two or more characteristics of the current user may then for instance be considered to form a profile of the current user. For each model, then a respective set of parameters may be determined by the training module (or by respective training modules) and provided to the prediction module (or to respective prediction modules) from time to time for updating purposes.

In this embodiment, a plausibility check may be performed with respect to at least two characteristics predicted by their respective models. For instance, if one characteristic is a family status of the current user, and another characteristic of the current user is an age range of the current user, it may be checked of the family states plausibly matches the age range, to avoid contradictory results. Such contradictory results may be fed back to the training module (or training modules) to enhance the process of determining the respective sets of parameters.

According to an embodiment of all aspects of the invention, the characteristic pertains to demographic information, in particular information on one of gender, race, age, family status, disabilities, mobility, home ownership, employment status, location and income, or to information on an interest, in particular an interest in a specific topic or product type.

Further advantageous embodiments of the invention are described by the detailed description presented hereinafter in conjunction with the accompanying drawings. It is to be understood, however, that the drawings are designed solely for purposes of illustration and not as a definition of the limits of the invention, for which reference should be made to the appended claims. It should further be understood that the drawings are not drawn to scale and that they are merely intended to conceptually illustrate the structures and procedures described therein. In particular, presence of features in the drawings should not be considered to render these features mandatory for the invention.

### BRIEF DESCRIPTION OF THE FIGURES

In the figures shown:

FIG. 1 is a schematic block diagram of an exemplary embodiment of a system for predictive behavioural targeting according to the invention;

FIG. 2a is a flowchart of an exemplary embodiment of a method according to the invention;

FIG. 2b is a flowchart of a further exemplary embodiment of a method according to the invention;

FIG. 3 is a schematic block diagram of an exemplary embodiment of an apparatus according to the invention;

FIG. 4 is a schematic illustration of a web page with an embedded web bug triggering predictive behavioural targeting according to an exemplary embodiment of the invention;

FIG. 5a is a representation of a plurality of training sets according to an exemplary embodiment of the invention;

FIG. 5b is a schematic illustration of two sets of vectors being separated by a hyperplane of a support vector machine according to an exemplary embodiment of the invention; and

FIG. 6 is a flowchart of an exemplary embodiment of a method for predicting a characteristic of a user based on a set of parameters and on an observed click behaviour according to an exemplary embodiment of the invention.

### DETAILED DESCRIPTION OF EMBODIMENTS OF THE INVENTION

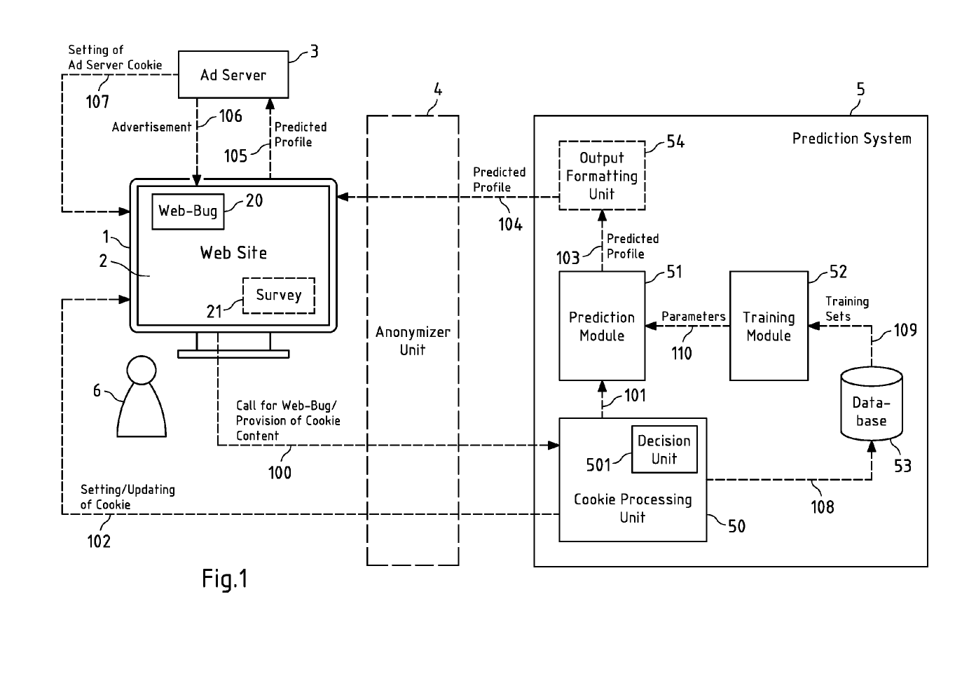

FIG. 1 is a block diagram of an exemplary embodiment of a system according to the invention.

The system of FIG. 1 comprises a terminal 1 operated by user 6, an ad server 3, an optional anonymizer unit 4 and a prediction system 5, which in turn comprises a plurality of components further discussed below.

Terminal 1 is represented by any computer that is used by a user 6 to interact with a web page 2 in the Internet. The user's computer can be a personal computer or another network capable device like a digital assistant (PDA), a mobile phone like a smart phone, a pager, a video game system, etc. The web page 2 is a location in the Internet owned by persons that provide media sites, social networks and/or retailer sites, for example.

Prediction system 5 can for instance be operated by the owner of web page 2 who wishes to have advertisement information targeted to a user 6 on his/her web page 2 based on one or more predicted characteristics of the user 6. However, the invention is also particularly advantageous when the prediction system 5 is operated by a service provider that offers the service of predicting one or more characteristics (e.g. a profile) of user 6 of web page 2 to allow targeting of advertisement information by ad server 3 to this user 6 based on the predicted characteristics. Then the service of the prediction system 5 is offered to owners or publishers of web pages in order to deliver appropriate advertisements to visitors of their web pages.

It is readily understood that, in FIG. 1, the presence of only one user 6 accessing web page 2 is for the sake of simplicity of presentation. Web page 2 may be accessed by a plurality of users via respective terminals, and for each of these users, prediction system 5 would be able to provide a predicted profile. Similarly, in FIG. 1, the presence of only one web page 2 and one associated ad server 3 is for the sake of simplicity of presentation. Prediction system 5 can of course operate with a plurality of different web pages and associated ad servers.

Prediction system 5 comprises a cookie processing unit 50, a prediction module 51, a training module 52, a database 53 and an optional output formatting unit 54. Basically, all of the components can be implemented as distinct apparatuses that communicate with each other. These apparatuses can be positioned at locations that are remote with respect to each other, for instance with distances of several hundred meters between them. Equally well, some of these components may be joined in one or more respective distinct apparatuses, or all components may be joined in one apparatus. Parts of prediction system 5 may implement functionality of a web browser. Accordingly, at least parts of prediction system 5 may constitute a web browser with enhanced functionality.

Particularly relevant for the operation of prediction system 5 is prediction module 51, which obtains (see step 101) information on the click behaviour (as a special case of access behaviour) of a user 6 (a current user) that is accessing web page 2 on a web browser operated by terminal 1, and predicts, in response to and based on the information on the click behaviour, and on a prediction model which in turn is based on a set of parameters, a characteristic of user 6 (see step 103). Prediction module 51 may equally well predict several characteristics based on respective prediction models with respective sets of parameters. These one or more predicted characteristics form a predicted profile that is output by prediction module 51 to output formatting unit 54 (see step 103) and forms the basis for the selection of an advertisement for inclusion into web page 2 that is particularly targeted to user 6. Output formatting unit 54 is however optional, its functionality may for instance be included in prediction module 51 or may not be necessary, since for instance the output of prediction module 51 already satisfies format requirements of ad server 3.

A further particularly relevant component of prediction system 5 is training module 52, which determines updates of the sets of parameters and provides these updates to prediction module 51 (see step 110) to be used by its prediction models for predicting the characteristics of user 6. These updates are determined by training module 52 based on training sets stored in and obtained from database 53 (see step 109), wherein each training set comprises, for a respective training user associated with the training set, information on his/her click behaviour and information on his/her characteristics, which may for instance have been derived directly and indirectly from online surveys.

According to embodiments of the invention, the operation of the prediction module 51 and the training module 52 is decoupled and asynchronous. Prediction module 51 is an online module that reacts to incoming information on a click behaviour of user 6 (see step 101) that is accessing web page 2 and produces, in real-time, a predicted profile for user 6 (see step 103). In contrast, the updates of the sets of parameters are not determined and provided in real-time. A possible trigger event for an update of the sets of parameters by the training module 52 may for instance be that, in database 53, a number of newly received or updated training sets has reached a pre-defined number. This functional separation of prediction module 51 and training module 52 becomes possible by using parametric prediction models that do not require access to database 53 for every prediction that has to be made. It allows for a considerably quick prediction of profiles by prediction module 53 (on the order of a few milliseconds only) and exhibits the further advantage that predictions can be made for users for which no dedicated profile is available, as it is generally required in prior art behavioural targeting systems. Therefore, profiles can be predicted for users that are completely unknown to prediction system 5 before they first access web page 2 (“first clickers”), and basically at the same speed as compared to a user for which a detailed click behaviour is already available.

Cookie processing unit 50 of prediction module 5 handles the setting of cookies in (see step 102) and the reception of information stored in cookies from (see step 100) the web browser of terminal 1. This may partially be functionality implemented by a web browser. If information in the cookies is compressed and/or encrypted, the compression/decompression and/or encryption/decryption may also be performed by cookie processing unit. Cookies represent one possibility to obtain information on the click behaviour of user 6. To this end, it is necessary that a so-called web bug 20 (also denoted as tracking pixel or blind gif) is included into web page 2 by the publisher of the web page. Alternatively, for instance a tracking script may be centrally deployed in the web site that comprises the web page and may then be associated with some or all web pages of the web site. The web bug may for instance be an HTML image tag that specifies a Uniform Resource Locator (URL) where image data is to be downloaded (As an alternative, the web bug may be implemented as a script, e.g. as a JavaScript image object). This image data is usually only a 1×1 pixel image that does not interfere with the rest of web page 2 (it may for instance be transparent). However, the web bug causes the web browser to request the image data from the web server that is associated with the domain specified in the URL. In prediction system 5, cookie processing unit 50 is responsible for setting cookies on web browsers that request data from the domain associated with prediction system 5 and do not yet have a cookie set for this domain (see step 102). The cookies may for instance be time-limited, for instance to one year. As an example, in the following, the domain of prediction system 5 is assumed to be “nugg.ad”. Now, when user 6 accesses web page 2 with web bug 20 therein for the first time (or re-accesses the site after deletion or expiry of an already existing cookie), and if web bug 20 specifies image data in the domain “nugg.ad”, cookie processing unit 50, upon receiving the request for image data, will respond with instructions for the web browser of user 6 to store a cookie in the web browser (HTTP set-cookie) for the domain “nugg.ad” (the path parameter of the cookie may for instance simply be “/”). When user 6 accesses web page 2 including web bug 20 with his web browser again, or accesses any other web page that has a web bug specifying any image data in the domain “nugg.ad”, the web browser of user 6 will automatically provide the contents of the stored cookie to cookie processing unit 50 (see step 100). In its response, cookie processing unit 50 can then write updated information into the cookie to be again stored in the web browser (see step 102). Since the cookie pertains to a domain that is different to the domain of web page 2, this cookie is usually referred to as “third-party-cookie”. In embodiments of the present invention, the cookie in the web browser of user 6 (and equally in the respective web browsers of other users) is used to store information on the click behaviour of user 6 in a decentralised manner.

In embodiments of the invention, the information on the click behaviour is represented by a content category histogram that indicates how often accessing of web pages pertaining to a specific content category by a user has been observed. Examples of content categories are culture, sports, arts, entertainment, business, politics, etc. This content category histogram is stored in a cookie.

The decision to which content category web page 2 accessed by user 6 pertains is made by decision unit 501, which, in FIG. 1, is exemplarily assumed to be a subcomponent of cookie processing unit 50. Equally well, decision unit could constitute a distinct component of prediction system 5. The decision made by decision unit 501 is for instance based on a content classifier that is for instance selected from a limited set of content categories by the publisher or owner of web page 2 and included as a parameter into web bug 20 of web page 2. Alternatively, decision unit 501 may derive a content category from a title or at least a part of the content of web page 2, for instance by parsing. An identifier of web page 2 enabling decision unit 501 to access web page 2 may for instance be obtained as the HTTP referer or may explicitly be included by the publisher or owner of web page 2 into web bug 20 as a parameter. When user 6 accesses web page 2 and the web browser of user 6 parses web bug 20 and accordingly requests image data from the domain “nugg.ad” associated with prediction system 5, decision unit 501 thus determines the content category of web page 2. If a cookie for the domain “nugg.ad” has already been set at the web browser of user 6 before, the contents of this cookie are provided to cookie processing unit 50 when requesting the image data. Decision unit 501 may then update the content category histogram obtained from the cookie and write the updated content category histogram into the cookie. If no cookie for the domain “nugg.ad” has been set at the web browser of user 6 before, decision unit 501 creates an empty content category histogram, adds a hit for content category of web page 2 to the content category histogram and writes this content category histogram into a cookie for the domain “nugg.ad” at the web browser of user 6. Consequently, if web bug 20 is contained in a plurality of different web pages with respectively different content, and if user 6 accesses a plurality of these web pages, the content histogram stored in the cookie on the user's web browser adequately reflects the content categories the user is interested in. Furthermore, it is readily clear that the decision unit 501 of the cookie processing unit 50 is able to provide a content category histogram (for instance to prediction module 51, as indicated by arrow 101) already upon a first click of user 6 on a web page that contains the web bug 20, i.e. when no cookie for the domain “nugg.ad” has yet been stored on the web browser of user 6. It is also apparent that cookie metering unit 50 can provide an updated version of the content category histogram for user 6 to database 53 (as indicated by arrow 108) each time user 6 accesses a web page (like web page 2) that contains web bug 20 (or a similar web bug associated with the domain “nugg.ad”). The updated content category histogram of a user (which in this context is referred to as a “training user”) forms one part of a training set stored in database 53, with the other part being information on one or more characteristics of the training user, which is for instance obtained from an online survey conducted with the training user.

Output formatting unit 54 of prediction system 5 receives predicted profiles from prediction module 51 (see step 103) and converts these profiles into a format that is required by ad server 3 as the final recipient of the predicted profile (see step 104). Formatting may include logical and/or technical formatting. Logical formatting may for instance comprise combining one or more predicted characteristics into a new characteristic, or deriving a characteristic from one or more predicted characteristics. Technical formatting may for instance comprise transforming a data format and/or syntax of one or more predicted characteristics. The format requirements of ad server 3 may for instance be defined in the web bug 20, for instance via one or more parameters thereof.

Anonymizer unit 4 is an optional component that serves the purpose of resolving privacy concerns that may arise with respect to the tracking of the click behaviour of users. To this end, communication between the web browser of user 6 and prediction system 5 is routed via anonymizer unit 4, which anonymizes the IP address of user 6 and only provides this anonymized IP address to prediction system 5. Prediction system 5 thus cannot link the click behaviour of user 6 with the actual IP address of user 6. Nevertheless, to be able to provide the predicted profile back to the web browser of user 6, prediction system 5 can use the anonymized IP address of user 6, which is then mapped to the original IP of user 6 by anonymizer unit 4. Anonymizer unit 4 is for instance operated by a third party who has agreed not to link the recorded click behaviour and/or the resulting predicted profiles to the IP address of a user in any way. Anonymizer unit 4 acts as a processor of data for the prediction system 5 and, preferably, has a contractual agreement that all data communication between prediction system 5 and web browsers of users (like user 6) is sent through an anonymization server in a data centre that is administrated by anonymizer unit 4 alone. The prediction system 5 has no access to this server. Anonymizer unit 4 creates an anonymized IP address (for instance by applying a hash function to the IP address). Anonymizer unit 4 preferably does not store any data about the click behaviour of a user. Anonymizer unit 4 only forwards this data. Anonymizer unit 4 may for instance represent a proxy, in particular a reverse proxy. As a further feature, anonymizer unit 4 may derive information on the location of a user (so-called geo-information), for instance information about the state or even federal state from the user's IP address, for instance by using an Apache server module like “Geo-IP”. An exact information about the actual location of the user can not be obtained by using this module, it is just a probable assumption of the state/federal state where the user is currently located. This geo-information may for instance be provided to prediction system 5 and may for instance be added as a characteristic to the training sets stored in database 53. Alternatively, this information may be added to the profile predicted by prediction module 51 as further characteristic and provided (potentially after formatting in output formatting unit 54) to ad server 3 for targeting. Targeting then may have components of predictive behavioural targeting and of geo- or location-based targeting.

Ad server 3 is responsible for selecting and serving advertisements to web page 2. For instance, web page 2 may comprise an empty horizontal space at its top where a banner advertisement shall be placed. To this end, web page 2 may include a script for communication with ad server 3. When the script is executed by a web browser, a request for an advertisement is sent to ad server 3, which selects the advertisement from a pool of available advertisement and returns parameters (and for instance the selected advertisement or a link to the advertisement) to the web browser. To implement predictive behavioural targeting, it is necessary to provide ad server 3 with information on the profile predicted for user 6 by prediction system 5. This may for instance be accomplished by using, in the response (see step 104) to the request initiated by the web bug 20 (see step 102), a location redirect instruction, wherein the location redirect instruction contains the address of ad server 3 as well as information on the predicted profile. This causes the web browser of user 6 (operated by terminal 1) to contact ad server 3 (see step 105) and to provide ad server 3 with the information on the predicted profile, which can then be used by ad server 3 to select an advertisement for web page 2 that matches the profile predicted for user 6. Furthermore, ad server 3 may, in response to the request of step 105, instruct the web browser of user 6 to set an ad server cookie (see step 107), which stores the profile predicted for user 6. In this way, ad server 3 has access to the predicted profile whenever user 6 accesses a web page that is associated with the domain of ad server 3 (for instance because the web page requests data from the ad server's domain, e.g. via a web bug). Predictive behavioural targeting thus is possible for ad server 3 even when the web bug 20 associated with the domain of the prediction system 5 is not included in a web page accessed by user 6 for which ad server 3 shall serve an advertisement.

So far, FIG. 1 has been used to explain how a profile is predicted for a user (user 6) that currently accesses a web page (web page 2). As explained above, the profile is predicted by prediction module 51 of prediction system 5 based on respective prediction models for each characteristic contained in the profile, wherein a set of parameters exists for each prediction model, and wherein the sets of parameters are generated and updated from time to time by training module 52 based on a plurality of training sets stored in database 53.

FIG. 1 can also be used to explain how the training sets in database 53 are obtained. To this end, user 6 of FIG. 1 is no longer considered as a user for which a profile shall be predicted, but rather as a user that accesses web page 2 and participates in a survey 21 presented to him. User 6 is then considered as a training user, since he contributes to one of the training sets stored in database 53. Therein, the mechanism of the web bug 20 included in web page 2 is assumed to remain in place, i.e. accessing of web page 2 by user 6 causes the cookie processing unit 50 to be activated, so that a content category histogram for user 6 is initialized and enriched by a hit for the content category of web page 2, if no cookie for the domain “nugg.ad” was stored on the web browser of user 6, or so that an existing content category histogram stored in a cookie on the web browser of user 6 is updated with the content category of web page 2 (see step 100). In both cases, the content category histogram is provided by cookie processing unit 50 to database 53 for storage, together with the anonymized IP address of user 6.

Now, when user 6, in addition to accessing web page 2, participates in the survey 21 by answering the questions of the survey, information on the results of the survey is also provided to database 53, together with the anonymized IP address of user 6 (for instance via a HTTP request, for instance also via the cookie processing unit 50). Via the anonymized IP address, the information on these answers can now be linked with the content category histogram for user 6 and can be stored therewith to form a training set for training user 6. The information on the results of the survey may for instance correspond to at least some of the characteristics that can be predicted by prediction module 51. For instance, a gender and/or an age range may be directly asked from user 6 in the survey. The survey may, in more general terms, comprise questions concerning demographics, lifestyle and product interests of user 6, to name but a few examples.

The survey 21 may not be presented to each user 6 that accesses web page 2, but only to a small, random sampling of users of web page 2. Thereby, the web page 2 may ask users to participate in the survey, and only if a user agrees, said information can be retrieved. The survey may for instance be served by an ad server that is associated with web page 2, like ad server 3 for example.

Users presented an online questionnaire are preferably informed about the voluntariness of the survey in a transparent and decisive manner. Users may especially be informed about the purpose of the survey (improve advertising). Survey results may for instance not be stored in a cookie. The amount of users that are presented the survey can be under 1% of the number of all users (e.g. of all users accessing web page 2). Preferably, the percentage amounts from 0.02% up to 0.05%.

The survey results and the information on the click behaviour can be exploited for targeted advertising and are collected and mined to generate predictive models. The underlying idea is that users with similar click behaviour regularly demonstrate a similar demographic profile and vice versa. By using these predictions, publishers and web page owners can be served profiles with greater relevance for advertising. This enables the publisher/web page owner to serve the appropriate advertisements to each user based on the predictions made by the prediction system 5, for instance in relation to the demographics, product interests and/or lifestyle of this user. The result can, for example, be that a web page visitor of an online shop for food who is assumed to be financially well situated and to have a “sustainable” lifestyle is offered advertisements about especially environmental-friendly products.

If user 6 visits multiple web pages from different publishers that all use the profile prediction service of the prediction system 5, the cookie set on the web browser of user 6 will contain data from all concerning publishers. Thereby, the click behaviour information (e.g. the content category histogram) is stored separately in the cookie for the different publishers and is separately processed and exploited. Preferably, a publisher cannot access data regarding the visits of web pages of other publishers. Furthermore, profiles may always be predicted solely based on cookie information that relates directly to the visit of the concrete publishers web pages and not to visits of web pages of other publishers. This also holds for the derivation of the sets of parameters from the training sets, i.e. sets of parameters to be used for predicting a profile for a web page of a publisher are only derived from training sets that contain information pertaining to the web pages of this publisher.

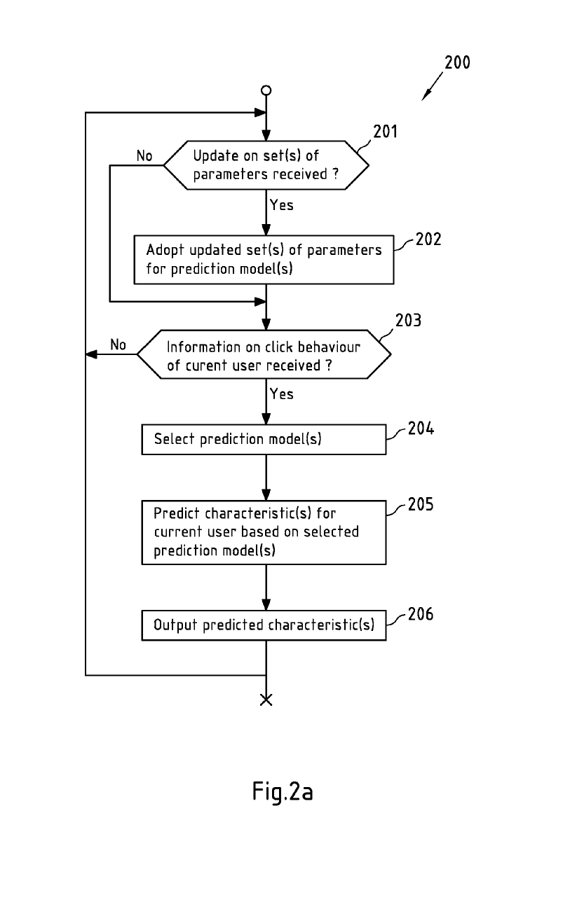

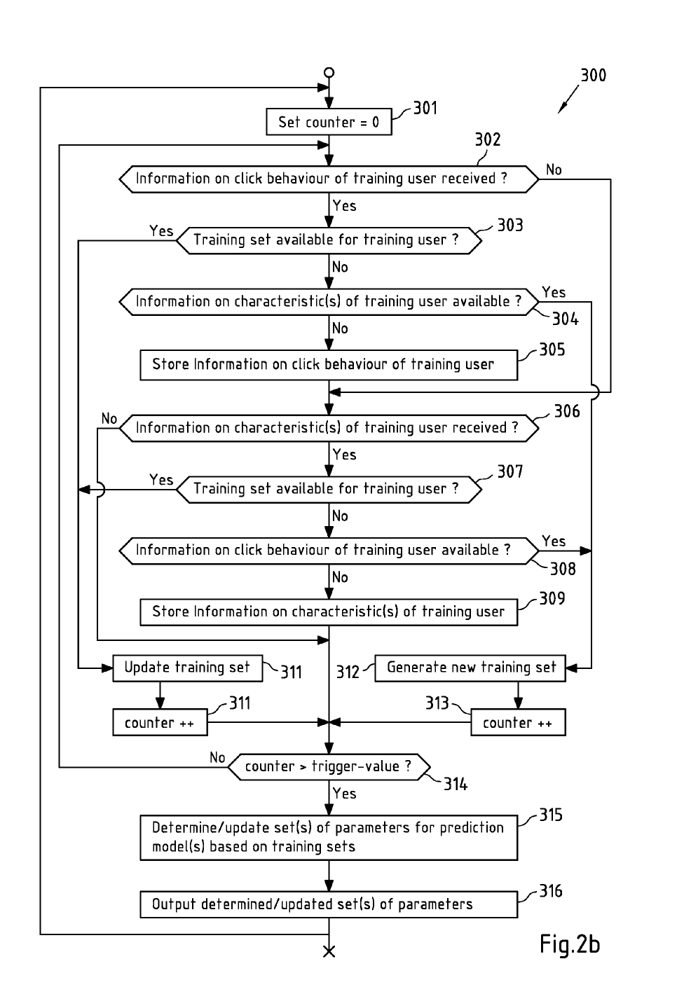

FIG. 2a shows a flowchart 200 of an exemplary embodiment of a method according to the invention. The steps 201-206 of this flowchart reflect functionality implemented by prediction module 51 (see FIG. 1). In a first step 201, it is checked if an update of one or more sets of parameters has been received from training module 52 (see FIG. 1). Each of these sets of parameters pertains to a respective prediction model, which in turn can be used to predict a characteristic of a current user (like user 6 of FIG. 1), i.e. a user that is currently accessing a web page for which predictive behavioural targeting shall be performed. If the checking reveals that an update has been received, the updated set(s) of parameters are adopted in step 202, for instance by replacing the existing set(s) of parameters with the new set(s) of parameters. In a step 203, it is then checked if information on a click behaviour of the current user has been received. If this is the case, one or more prediction models respectively required for prediction one or more characteristics of the current user are selected in a step 204. Information on a choice of the characteristic(s) that shall be predicted is for instance obtained together with the information on the click behaviour of the current user (for instance as a parameter of a web bug). In a step 205, then characteristic(s) for the current user are predicted based on the selected prediction model(s). If the selected prediction model(s) are based on respective set(s) of parameters that have been updated in step 202, the updated set(s) of parameters are used for the prediction in step 205. Otherwise, non-updated set(s) of parameters are used. Step 205 may optionally also comprise a normalization of the click behaviour of the current user, as will be discussed with respect to equation (4) below. Finally, in step 206, the predicted characteristic(s) are output, for instance to output formatting unit 54 (see FIG. 1).

FIG. 2b shows a flowchart 300 of a further exemplary embodiment of a method according to the invention. The steps 301-316 of this flowchart describe the reception and storage of information pertaining to training sets in database 53 (see FIG. 1), which is represented by steps 301-314, and the determination or updating of one or more sets of parameters based on the training sets by training module 52 and the output thereof, which is represented by steps 315-316. Steps 301-314 may for instance be performed by a unit that controls database 53, for instance by cookie processing unit 50. Steps 315-316 may for instance be performed by training module 52.

In a first step 301, a counter variable is initialized to zero. In a step 302, it is then checked if information on a click behaviour of a training user (like user 6 in FIG. 1) has been received. If this is not the case, the flowchart jumps to step 306. Otherwise, it is checked if a training set (with both information on the click behaviour of the training user and information on one or more characteristics of the training user) is already available in database 53 (step 303). If this is the case, the information on the click behaviour of the training user can be updated in the existing training set in step 310, and the counter variable is incremented by one (step 311). Otherwise, in step 304, it is checked if information on one or more characteristics of the training user is available (but not yet stored in a training set for this training user). If this is not the case, the information on the click behaviour of the training user is stored in step 305 (for instance in database 53, or in another storage location, but not yet as part of a training set). Otherwise, a new training set comprising the information on the click behaviour of the training user and the information on the characteristic(s) of the training user can be generated and stored in database 53 in step 312, and the counter variable is incremented by one (step 313).

After step 305, or if the checking of step 302 yields a negative result, it is checked in step 306 if information on one or more characteristics of a training user has been received. If this is not the case, the flowchart jumps to step 314. Otherwise, it is checked if a training set (with both information on the click behaviour of the training user and information on one or more characteristics of the training user) is already available in database 53 (step 307). If this is the case, the information on the characteristic(s) of the training user can be updated in the existing training set in step 310, and the counter variable is incremented by one (step 311). Otherwise, in step 308, it is checked if information on a click behaviour of the training user is available (but not yet stored in a training set for this training user). If this is not the case, the information on the characteristic(s) of the training user is stored in step 309 (for instance in database 53, or in another storage location, but not yet as part of a training set). Otherwise, a new training set comprising the information on the click behaviour of the training user and the information on the characteristic(s) of the training user can be generated and stored in database 53 in step 312, and the counter variable is incremented by one (step 313).

In step 314, it is then checked if the counter variable is larger than a pre-defined trigger-value. If this is the case, a sufficient number of training sets is considered to be present to allow determining (if no set(s) of parameters exist so far) or updating (if set(s) of parameters already exist) of one or more sets of parameters for prediction models based on the training sets stored in database 53, and this determining or updating is performed in step 315 (by training module 52), and the determined or updated set(s) of parameters are output in step 316 (to prediction module 51). The flowchart then returns to step 310, where the counter variable is reset to zero. The flowchart then is repeated as described above.

Therein, step 315 may optionally also comprise a normalization of the training sets of the training users, as will be discussed for the current user with respect to equation (4) below.

In the above description of the flowchart 300 of FIG. 2b, it was exemplarily assumed that training sets for training users are only generated and stored in database 53 if both information on the click behaviour of a training user and information on the characteristic(s) of the training user are available. It is of course also possible to store information pertaining to a training user (i.e. information on the click behaviour of a training user or information on the characteristic(s) of a training user) always directly in database 53, irrespective of the fact whether the complementary information required to form a training set is already available or not. Nevertheless, a training set for a training user may then still only be considered to be present in database 53 if both the information on the click behaviour of the training user and the information on the characteristic(s) of the training user are present. As soon as this is the case for a training user (in response to reception of either the information on the click behaviour or the information on the characteristic(s) of the training user completing the training set), the counter for a new training set in database 53 may be incremented by one. Subsequent reception of information on a click behaviour and/or on characteristic(s) of a training user for which already a training set is considered to exist leads to an update of this training set and thus also to an incrementation of the counter by one.

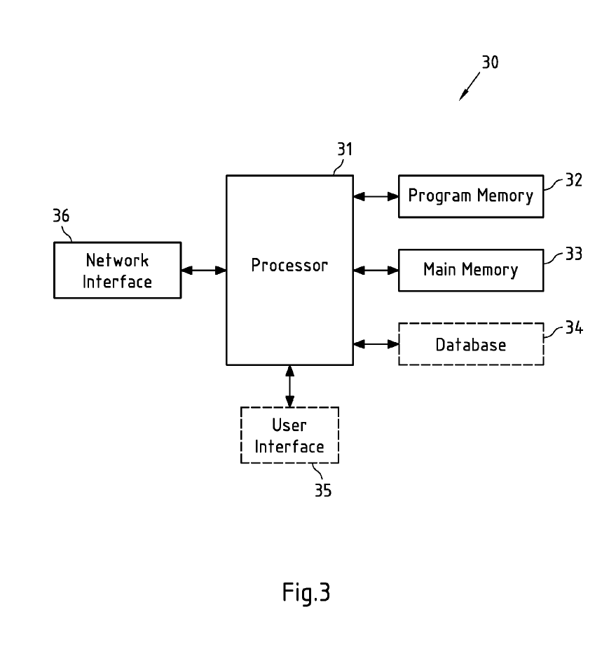

FIG. 3 is a schematic block diagram of an exemplary embodiment of an apparatus 30 according to the invention. Apparatus 30 may for instance be a web server or at least a part thereof. Apparatus 30 may for instance be configured to perform the steps of flowchart 200 of FIG. 2b and/or flowchart 300 of FIG. 3b. Accordingly, apparatus 30 may for instance implement the functionality of prediction module 51 (see FIG. 1) and/or training module 52 and/or database 53. Furthermore, apparatus 30 may also implement functionality of cookie processing unit 50 and/or output formatting unit 54.

Apparatus 30 comprises a processor 31, which may for instance be embodied as a microprocessor, Digital Signal Processor (DSP) or Application Specific Integrated Circuit (ASIC), to name but a few non-limiting examples. Processor 31 executes a program code stored in program memory 32. Program memory 32 may also be included into processor 31. Program memory 32 may be fixedly connected to processor 30, or removable from processor 30, for instance in the form of a memory card or stick. Program memory 32 and the computer program code stored therein may be configured to, with processor 31, cause apparatus 30 at least to perform the methods according to the first aspect of the invention or its exemplary embodiments described above. Program memory 32 may constitute a tangible storage medium that comprises a computer program with program code for performing the method according to the first aspect of the invention or any of its above-described embodiments, when the computer program is executed on processor 31.

Processor 31 further interfaces with a main memory 33, which may for instance be embodied as a Random Access Memory (RAM) to support its operation.

Apparatus 30 may optionally comprise database 34, which may for instance represent the database 53 of FIG. 1. Processor 31 then is able to access (e.g. read from and/or write to) database 34, which may for instance be embodied as a mass storage device, for instance with capacities of several Gigabytes or several Tera-bytes. It may either be fixedly connected to processor 31, or may be releasably connectable thereto.

Processor 31 further controls a network interface 36 configured to receive and/or output information. Via this network interface 36, for instance communication of apparatus 30 with at least some of the components of prediction system 5 (see FIG. 1) that are not implemented by apparatus 30 is possible. Via network interface 36, apparatus 30 may for instance communicate with the web browser of user 6 (if anonymizer unit 4 is not deployed), or with anonymizer unit 6 (if anonymizer unit is deployed), for instance if apparatus 30 implements cookie processing unit 50 and/or output formatting unit 54. Network interface 36 may for instance allow communication with one or more peers according to the HTTP protocol.

Apparatus 30 may optionally also comprise a user interface 35 configured to present information to a user/operator of apparatus 30 and/or to receive information (e.g. configuration parameters such as for instance the trigger_value of step 314 of flowchart 300 (see FIG. 2b)) from such a user/operator.

It is to be noted that the circuitry formed by the components of apparatus 30 may be implemented in hardware alone, partially in hardware and in software, or in software only.

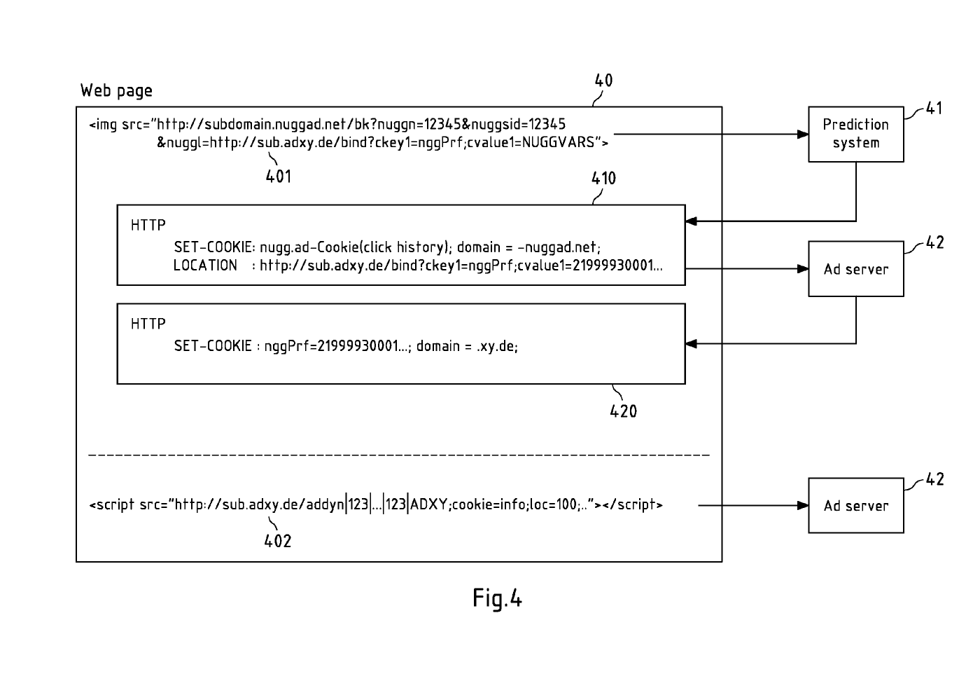

FIG. 4 is a schematic illustration of a web page 40 with an embedded web bug 401 triggering predictive behavioural targeting according to an exemplary embodiment of the invention. Web bug 401 here exemplarily takes the shape of an image tag. The general syntax of web bug 401 is explained below:

<img src=”http://subdomain.nuggad.net/bk?nuggn=12345&nuggsid=12345&nuggrid=
http://site.com &nuggtg=contentClassifier&nuggl=location”>

Therein, the actual Uniform Resource Locator (URL) of the image (e.g. a 1×1 transparent pixel) “http://subdomain.nuggad.net/bk” is followed by a number of parameters, which are defined as follows:
nuggn network-id, defined by operator of prediction system 41
nuggsid site-id, defined by operator of prediction system 41 nugg.ad (optional)
nuggrid referrer-url (e.g. stated by publisher/owner of the web page), if http referrer can't be used, url-encoded (optional, but recommended if for instance nuggsid cannot be used)
nuggtg content classifier (i.e. ‘sports’), url-encoded (optional; for instance if http referrer cannot be used)
nuggl redirect location, url-encoded (http header LOCATION; ad server cookie writing API)

When web page 40 is accessed by a user (e.g. user 6 in FIG. 1), the web bug 401 causes a request for the image data defined by the web bug's URL from the domain (“nugg.ad”) associated with prediction system 41 (which corresponds to prediction system 5 of FIG. 1). The parameters included in the web bug are then also transferred to prediction system 41 and allow classifying a content of web page 40 (e.g. based on the content classifier nuggtg). In response to this request, the prediction system 41 returns the instructions 410 to be executed by the user's web browser. In particular, a cookie for the domain “nugg.ad” is set via HTTP SET-COOKIE (that stores the content category histogram that is at least based on the content category of web page 40). Furthermore, a location redirect is triggered via HTTP LOCATION, i.e. the user's web browser is instructed to contact ad server 42 based on the URL included in the nuggl parameter of the web bug. Therein, the value “NUGGVARS” of parameter cvaluel appended to the URL of the add server as contained in parameter nuggl of web bug 401 is replaced by the profile predicted by prediction system 41 for the user that is accessing web page 40 in response to the request to prediction system 41, wherein this predicted profile “21999930001” follows the format required by the ad server and/or its cookie as discussed below. Thus with any accessing of a web page 40 that contains web bug 401 by a user, the content category of the web page 40 and the contents of the cookie stored for the domain “nugg.ad” are provided to prediction system 41, and a profile for the user is predicted and returned, via a location redirect, to the ad server 42 specified in web bug 401.

Ad server 42 then sets an ad server cookie (via HTTP SET-COOKIE) for its domain (e.g. “adxy.de”) that contains the predicted profile on the user's web browser, as shown by HTTP response 420. Once this ad server cookie is written, it can be used to target ads on each web page that is accessed with the user's web browser and has a request for data from ad server 42 included or associated therewith, such as script 402, which contacts ad server 42 for an advertisement to be included into web page 40. When contacting ad server 42, the predicted profile for the user is provided to ad server 42 by the ad server cookie, so that ad server 42 can select an advertisement targeted to the user based on the predicted profile.

It is readily understood that the HTML image tag 401 described above is only an example of a web bug. Equally well, for instance a script code, e.g. a JavaScript Image Object, may be deployed for this task, and this script may for instance apply to plural web pages of a web site.

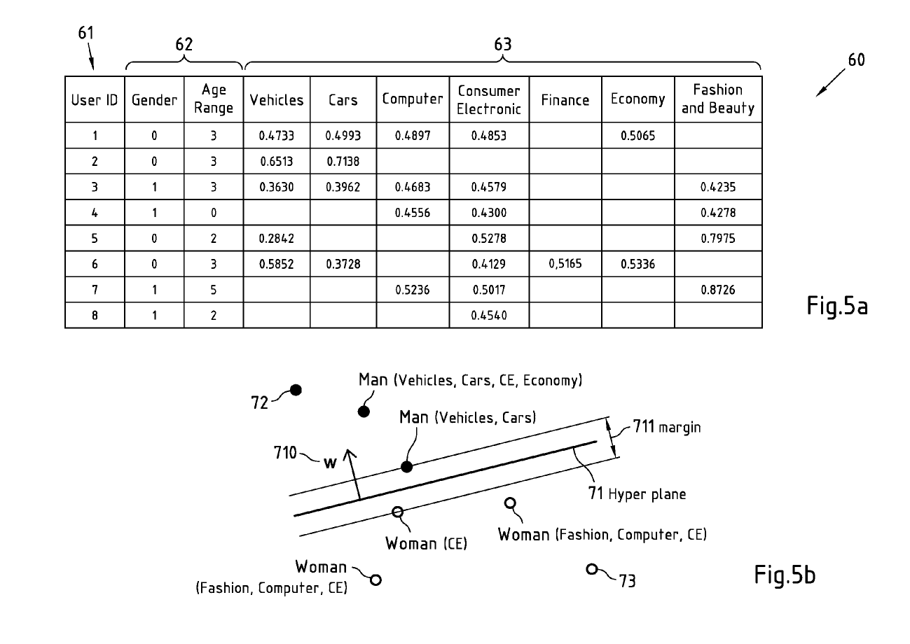

FIG. 5a shows, in table 60, a representation of a plurality of training sets according to an exemplary embodiment of the invention. Each line of table 60 may be understood as a training set. The first column 61 of table 60 comprises respective identifiers of the training users to which the training sets respectively pertain. These identifiers may for instance be anonymized identifiers as provided by anonymizer unit 4 (see FIG. 1). In FIG. 5a, these identifiers, for the sake of simplicity of presentation, have been simplified to simple numbers like “1”, “2”, etc. The second and third columns referred to by reference numeral 62 respectively contain characteristics of the users. Here, exemplarily only two characteristics are available, “gender” and “age range”. In the remaining columns referred to by reference numeral 63, the content category histogram of each training user is contained. Here, the content categories are exemplarily chosen as “vehicles”, “cars”, “computer”, consumer electronics”, “finance”, “economy” and “fashion and beauty”. Empty table cells in column range 63 express that, for the respective training user, no accesses of web pages pertaining to the respective content category have been observed. The non-empty table cells in column range 63 express—in (exemplary) normalized form (as explained with reference to equation (4) below)—, how often accessing of web pages pertaining to the respective content category has been observed for the respective training user. For instance, for user with id=1, it is known (e.g. from a survey) that he has the following two characteristics: he is male (gender=0) and has an age within age range=3. Furthermore, with respect to his click behaviour, the following content category histogram is known:

| | |
|---|---|
| Vehicles | 0.4733 |
| Cars | 0.4993 |
| Computer | 0.4897 |
| Consumer electronics | 0.4853 |
| Finance | 0 |
| Economy | 0.5065 |
| Fashion and beauty | 0 |

This content category histogram can be expressed as a seven-dimensional vector

x₁=(0.4733,0.4993,0.4897,0.4853,0,0.5065,0)

Similar vectors can be set up to represent the respective click behaviour of the further training users of table 60. According to embodiments of the invention, characteristics of a user are predicted based on a prediction model that allows classifying a vector associated with the user into one of at least two classes. For instance, if the characteristic is the gender of the user, a vector representing the click behaviour of the user can be classified as either belonging to a class “male” or to a class “female”.

Now, the training sets of table 60 can be used to determine a set of parameters for a prediction model for the characteristic “gender”, and to determine a set of parameters for a prediction model for the characteristic “age range”. Such a set of parameters can for instance be derived from the training sets based on a support vector machine, as will now be explained in more detail.

A description of support vector machines is given in article “Support-Vector Networks” by Corinna Cortes and Vladimir Vapnik in Machine Learning Vol. 20, Number 3 (1995), p. 273-297, which is incorporated herein in its entirety.

In particular, in the exemplary case of a linear support vector machine with an optimal hyperplane, a support vector machine determines, based on a set of N p-dimensional training vectors xₙ (with n=1 . . . N) with respectively associated class identifiers yₙε{−1, 1} a hyperplane

w·x+b=0 (1)

so that the following holds:

w·xᵢ+b≧1 if yᵢ=1, and

w·xᵢ+b≦1 if yᵢ=−1. (2)

Therein, the hyperplane is defined by its p-dimensional normal vector w and the so-called (scalar) bias b, and is determined so that the so-called margin, i.e. the distance of the training vectors of each of the two classes of training vectors (indicated by class identifiers yₙ) that are closest to the hyperplane is maximized.

FIG. 5b is a schematic illustration of two sets of training vectors xₙ 72, 73 being separated by a hyperplane 71 (with normal vector w 710 and margin 711) of a support vector machine according to an exemplary embodiment of the invention.

In FIG. 5b, only a two-dimensional scenario (i.e. a two-dimensional space 70) is exemplarily considered, and only two classes of training vectors xₙ 72, 73 are exemplarily separated by the hyperplane 71. The first class of training vectors xₙ are represented by solid dots 72 and pertain to male training users (e.g. yₙ=1). The second class of vectors xₙ are represented by circles 73 and pertain to female training users (e.g. yₙ=−1). For some of the vectors, also the content categories that are particularly pronounced for the respective training user are given in braces. It is thus for instance seen that a training user that has interests in consumer electronics is closer to the hyperplane 71 than a training user that has interests in fashion, computers and consumer electronics.

The principle of separation of vectors of different classes by a hyperplane can of course be extended to the multi-dimensional case. For instance, instead of two-dimensional vectors respectively containing the content category histograms of training users, seven-dimensional training vectors respectively containing the content category histograms as contained in column range 63 of table 60 of FIG. 5a could be used in a seven-dimensional space, and could be assigned to either a male or female class depending on the information in the second column of table 60. For these two classes of training vectors, then a hyperplane can be determined, yielding a set of parameters serving as a decision function to classify a corresponding content category histogram vector of a current user. The application of this decision function to a vector representing the click behaviour of a current user to predict characteristics of the current user will now be explained in more detail.

Once a hyperplane, that is defined by its normal vector w and bias b, is derived from a set of training vectors (in training module 52 of FIG. 1), a particularly simply classification of a vector xᵢ into one of the classes is possible. The decision function for this classification can be written as follows:

yᵢ=sgn(<w,xᵢ>+b). (3)

Therein, sgn (·) returns the sign of its argument, i.e. 1 for a positive argument and −1 for a negative argument, and <·,·> returns the inner vector product of its two arguments. This decision function can be computed with very low computational complexity in prediction module 51 (see FIG. 1) and thus enables real-time prediction of user characteristics, for instance within a couple of milliseconds.

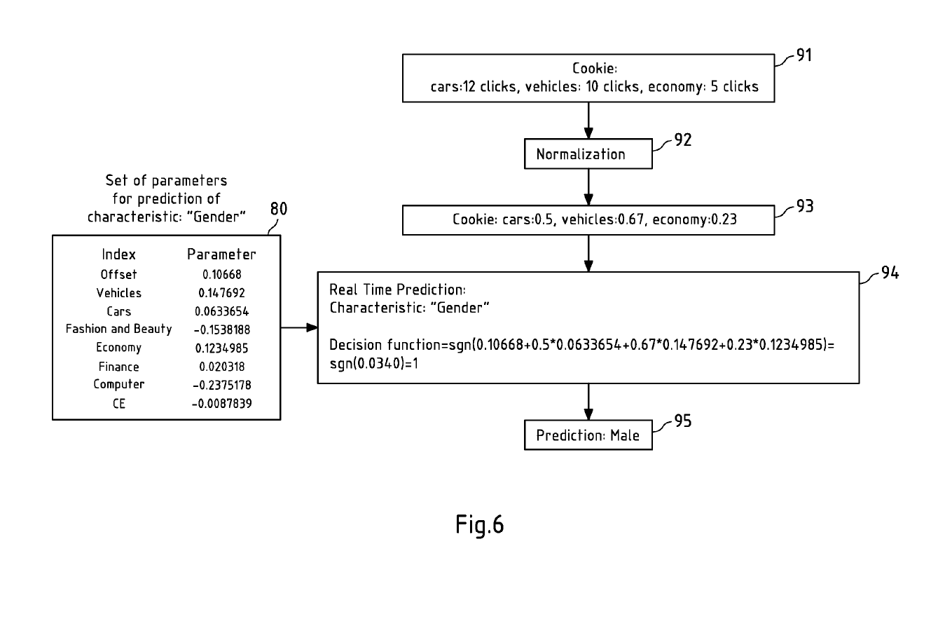

FIG. 6 is a flowchart of an exemplary embodiment of a method for predicting a characteristic of a current user based on a set of parameters 80 and on an observed click behaviour according to an exemplary embodiment of the invention.

In the left part of FIG. 6, an exemplary set of parameters 80 derived from a plurality of training sets for prediction of the user characteristic “gender” is illustrated. Therein, the parameters 80 have been determined according to the above-described support vector machine approach. The set of parameters 80 comprises an “Offset” value, which represents the bias of the hyperplane. Furthermore, the set of parameters 80 comprises weights that represent the components of the normal vector w of the hyperplane. Each of these weights is associated with one component of the vector of the current user, and thus with content categories “vehicles”, “cars”, “fashion and beauty”, “economy”, “finance”, “computer” and “consumer electronics”.

The right part of FIG. 6 shows the actual flowchart 90 for the prediction process (as it is for instance performed in prediction module 51 of FIG. 1. If the current user (e.g. user 6 of FIG. 1) accesses a web page containing the web bug for tracking the click behaviour, the content category histogram for the current user is updated and may for instance take the shape as shown in step 91 of flowchart 90, i.e. there have been 12 tracked clicks on web pages pertaining to content category “cars”, 10 tracked clicks on web pages pertaining to content category “vehicles” and 5 tracked clicks on web pages with content category “economy”. In an (optional) step 92, the content category histogram is normalized, to obtain the normalized content category histogram shown in step 93.

The normalization in optional step 92 may for instance serve the purpose of taking into account that clicks of a user on generally frequently accessed web pages have less impact than clicks of a user on generally less frequently access web pages (revealing special interests of the user). Normalization may for instance be based on the following formula:

$${p}_{n} = \frac{1}{1 + {e}^{- α \cdot \frac{{n}_{a} - {p}_{a} \cdot {N}_{a}}{\sqrt{p \cdot ( 1 - p ) \cdot {N}_{a}}}}} \qquad ( 4 )$$

Therein, pₐ denotes the normalized value, α is a constant factor, for instance in the range [0.01 . . . 1] (e.g. 0.4), nₐ denotes the number of clicks of the current user on web pages of a specific content category (e.g. in a specific (e.g. predefined) time interval), p denotes the overall probability of clicks on web pages of this specific content category (e.g. determined by statistical analysis of the number of accesses of a plurality of users on web pages of this specific content category), and Nₐ denotes the overall number of clicks of the current user on web pages (e.g. in the specific time interval) (for instance determined by summing the values nₐ of a user over all content categories). Normalization of the content category histogram of the current user may for instance be performed by prediction module 51 (see FIG. 1), for instance as a part of step 205 of the flowchart 200 of FIG. 2a. If normalization is applied to the content category histogram of the current user, it should also be applied to the content category histograms of the training users, e.g. by training module 52 (see FIG. 1), for instance in step 315 of flowchart 300 of FIG. 2b.

Then, in step 94, the decision function, which is based on the set of parameters 80, is calculated, as prescribed by equation (3) above. This yields a value of the decision function of yᵢ=1. In step 95, it is then determined, since the class identifier of the vector representing the click behaviour/content category histogram of the current user is yᵢ=1, that the current user is male.

It should be understood that the invention is not limited to support vector machines as classification algorithms. Equally well, other classification algorithms that allow decoupling training and prediction and thus allow for quick (real-time) predictions may be deployed. When a support vector machine is chosen, not necessarily optimal hyperplanes have to be determined Instead, for instance, also soft margin hyperplanes can be determined. It should also be understood that support vector machines are not bound to two-class classification. Equally well, classification of vectors into more than two classes is possible, for instance by applying so-called multiclass support vector machines. One approach here is to reduce the multiclass problem into multiple binary (two-class) classification problems.

With respect to the embodiments of the invention described above, it is understood that a disclosure of any action or step of a method according to this embodiment shall be understood as a disclosure of a corresponding (functional) configuration of an apparatus (for instance a configuration of the computer program code and/or the processor and/or some other means of the apparatus) according to this embodiment, of a corresponding computer program code defined to cause such an action or step when executed and/or of a corresponding (functional) configuration of a system (or parts thereof) according to this embodiment.

The embodiments of the invention presented above and their single features shall also be understood to be disclosed in all possible combinations with each other. It should also be understood that the sequence of method steps in the flowcharts presented above is not mandatory, also alternative sequences may be possible.

The invention has been described above by means of embodiments, which shall be understood to be non-limiting examples. In particular, it should be noted that there are alternative ways and variations which are obvious to a skilled person in the art and can be implemented without deviating from the scope and spirit of the appended claims.

1. An apparatus, comprising at least one processor; and at least one memory including computer program code, said at least one memory and said computer program code configured to, with said at least one processor, cause said apparatus at least to perform:
obtaining information on an access behaviour of a current user accessing content;
predicting, by a prediction module of said apparatus and in response to said obtaining of said information on said access behaviour of said current user, at least one characteristic of said current user at least based on a model for said characteristic and on said obtained information on said access behaviour of said current user, wherein said model is at least based on a set of parameters determined by a training module at least based on information from a plurality of training sets and provided to said prediction module from time to time for updating purposes, wherein each training set of said training sets comprises, for a respective training user of a plurality of training users, information on a access behaviour of this respective training user and information on said characteristic of this respective training user, and
providing information on said predicted characteristic of said current user to allow targeting of information to said current user at least based on said information on said predicted characteristic.

2. The apparatus according to claim 1, wherein said characteristic of said current user is predictable by a classification of a vector representing said information on said access behaviour of said current user into one of at least two classes, and where said model is based on a support vector machine that allows said classification.

3. The apparatus according to claim 2, wherein said set of parameters defines a decision function of said support vector machine that is applicable to said vector representing said information on said access behaviour of said current user to perform said classification.

4. The apparatus according to claim 2, wherein, for each training set of said training sets, said information on said access behaviour of said respective training user comprised in said training set represents a training vector that is associated with a class derivable from said information on said characteristic of said respective training user comprised in said training set, and wherein said set of parameters is determined by said training module to reflect a separation of training vectors of different classes according to a pre-defined optimization criterion.

5. The apparatus according to claim 1, wherein said information on said access behaviour of said current user comprises, for each content category of a set of one or more content categories, information on how often accessing of content pertaining to said content category by said current user has been observed in a time period, and wherein said information on said access behaviour of a respective training user comprised in said training sets respectively comprises, for each content category of a set of one or more content categories, information on how often accessing of content pertaining to said content category by said training user has been observed in a time period.

6. The apparatus according to claim 5, wherein a decision whether content pertains to one of said content categories is made by a decision unit based on a received content classifier and/or based on an analysis of at least a part of said content.

7. The apparatus according to claim 5, wherein said predicting of said characteristic of said current user is based on a representation of said information on said access behaviour of said current user in which said information on how often said current user has accessed content pertaining to content categories of said set of one or more content categories has been normalized, and wherein said set of parameters is determined based on training sets in which said respective information on how often said respective training user has accessed content pertaining to content categories of said set of one or more content categories has been normalized.

8. The apparatus according to claim 1, wherein at least a part of said information on said access behaviour of said current user is stored in a cookie on a web browser of said current user and is provided by said web browser.

9. The apparatus according to claim 8, wherein said information on said access behaviour of a training user of said training users is stored in a cookie on a web browser of said training user, wherein at least a domain for which said cookie has been set matches a domain for which said cookie stored on said web browser of said current user has been set.

10. The apparatus according to claim 1, wherein said information on said characteristic of a training user comprised in a training set of said training sets is obtained from a survey conducted with said training user and is associated with said information on said access behaviour of said training user to obtain said training set.

11. The apparatus according to claim 1, wherein an actual address of said current user is anonymized by an anonymizer unit, and wherein said information on said access behaviour of said current user is obtained with said anonymized address and not said actual address.

12. The apparatus according to claim 11, wherein said information on said predicted characteristic of said current user is provided with said anonymized address and not said actual address.

13. The apparatus according to claim 1, wherein said information on said predicted characteristic of said current user is formatted to match a format required by an ad server that performs said targeting of said information to said current user at least based on said information on said predicted characteristic.

14. The apparatus according to claim 1, wherein said provided information on said predicted characteristic of said current user is provided to an ad server that performs said targeting of said information to said current user at least based on said information on said predicted characteristic.

15. The apparatus according to claim 14, wherein said ad server triggers storage of said information on said predicted characteristic in a cookie on a web browser of said current user.

16. The apparatus according to claim 1, wherein an updated version of said set of parameters is determined by said training module and provided to said prediction module each time when a number of new and/or at least partially updated training sets has reached a pre-defined value.

17. The apparatus according to claim 1, wherein two or more characteristics of said current user are predicted, wherein each of said characteristics is predicted by a respective model.

18. The apparatus according to claim 17, wherein a plausibility check is performed with respect to at least two characteristics predicted by their respective models.

19. The apparatus according to claim 1, wherein said characteristic pertains to demographic information, in particular information on one of gender, race, age, family status, disabilities, mobility, home ownership, employment status, location and income, or to information on an interest, in particular an interest in a specific topic or product type.

20. A system, comprising:
an apparatus according to claim 1, and
said training module.

21. A method performed by at least one apparatus, said method comprising:
obtaining information on an access behaviour of a current user accessing content;
predicting, by a prediction module of said apparatus and in response to said obtaining of said information on said access behaviour of said current user, at least one characteristic of said current user at least based on a model for said characteristic and on said obtained information on said access behaviour of said current user, wherein said model is at least based on a set of parameters determined by a training module at least based on information from a plurality of training sets and provided to said prediction module from time to time for updating purposes, wherein each training set of said training sets comprises, for a respective training user of a plurality of training users, information on a access behaviour of this respective training user and information on said characteristic of this respective training user, and
providing information on said predicted characteristic of said current user to allow targeting of information to said current user at least based on said information on said predicted characteristic.

22. A tangible computer-readable medium having a computer program stored thereon, the computer program comprising program code for performing the following when said computer program is executed on a processor:
obtaining information on an access behaviour of a current user accessing content;
predicting, by a prediction module of said apparatus and in response to said obtaining of said information on said access behaviour of said current user, at least one characteristic of said current user at least based on a model for said characteristic and on said obtained information on said access behaviour of said current user, wherein said model is at least based on a set of parameters determined by a training module at least based on information from a plurality of training sets and provided to said prediction module from time to time for updating purposes, wherein each training set of said training sets comprises, for a respective training user of a plurality of training users, information on a access behaviour of this respective training user and information on said characteristic of this respective training user, and
providing information on said predicted characteristic of said current user to allow targeting of information to said current user at least based on said information on said predicted characteristic.
